(19) United States
(12) Patent Application Publication
(10) Pub. No.: US 2012/0272507 A1
(43) Pub. Date: Nov. 1, 2012

(54) ANCHORS FOR HOLDING A WIRE SHELF

(76) Inventor: Frank J. Dare, Souderton, PA (US)

(21) Appl. No.: 13/459,228

(22) Filed: Apr. 29, 2012

Related U.S. Application Data
(60) Provisional application No. 61/480,241, filed on Apr. 28, 2011.

(51) Int. Cl. A47B 96/06; B23P 11/00; F16B 45/00

(52) U.S. Cl. 29/525.01; 248/215

(57) ABSTRACT

A wall anchor is specially designed for mounting wire shelving systems to a wall. The wall anchor includes a threaded end to thread into the wall. The wall anchor is equipped with a clip that locks the shelving in place. Once the wall anchor is secured into the wall, wire shelving can snap in place in the clip. The wall anchor is made as a single piece, thereby providing quick and easy installation of wire shelving as compared with conventional two-piece designs. With the wall anchor, no hole preparation is necessary, the wall anchor has a tip that pre-drills its own small, precise hole in the wall, allowing the wall anchor to be used with gypsum wallboard, replacing plastic plugs and toggles.

### CROSS-REFERENCE TO RELATED APPLICATIONS

This application claims the benefit of priority of U.S. provisional patent application No. 61/480,241, filed Apr. 28, 2011, the contents of which are herein incorporated by reference.

### BACKGROUND OF THE INVENTION

The present invention relates to wall anchors and, more particularly, to a specialty anchor that can be used on gypsum board/drywall, once installed, to hold a wire shelf.

Hanging wire shelving on drywall can be a time consuming process, often involving multiple parts. Current devices can easily be pulled out of the wall. While some current devices need multiple parts to complete the same task.

As can be seen, there is a need for an improved single-piece wall anchor for wire shelving.

### SUMMARY OF THE INVENTION

In one aspect of the present invention, a wall anchor comprises a hooked end; an insertion end formed integrally with the hooked end; threads disposed along the hooked end; and a single point at a distal end of the insertion end, wherein the hooked end is adapted to secure onto wire shelving.

In another aspect of the present invention, a wall anchor comprises a hooked end; an insertion end formed integrally with the hooked end; threads disposed along the hooked end; a single point at a distal end of the insertion end; and a bit engagement area formed on a front surface of a rear arm of the wall anchor, wherein the hooked end is adapted to secure onto wire shelving; and the threads are of a deep thread design.

In a further aspect of the present invention, a method for securing wire shelving to a wall comprises screwing an insertion end of a wall anchor into the wall via threads formed in the insertion end; and disposing the wire shelving into a hooked end of the wall anchor, wherein the hooked end is formed integrally with the insertion end. These and other features, aspects and advantages of the present invention will become better understood with reference to the following drawings, description and claims.

### BRIEF DESCRIPTION OF THE DRAWINGS

FIG. 1 is a side view of a wall anchor according to an exemplary embodiment of the present invention;

FIG. 2 is a side perspective view of the wall anchor of FIG. 1; and

FIG. 3 is a front view of the wall anchor of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a wall anchor specially designed for mounting wire shelving systems to a wall. The wall anchor includes a threaded end to thread into the wall. The wall anchor is equipped with a clip that locks the shelving in place. Once the wall anchor is secured into the wall, wire shelving can snap in place in the clip. The wall anchor is made as a single piece, thereby providing quick and easy installation of wire shelving as compared with conventional two-piece designs. With the wall anchor of the present invention, no hole preparation is necessary, the wall anchor has a tip that pre-drills its own small, precise hole in the wall, allowing the wall anchor to be used with gypsum wallboard, replacing plastic plugs and toggles.

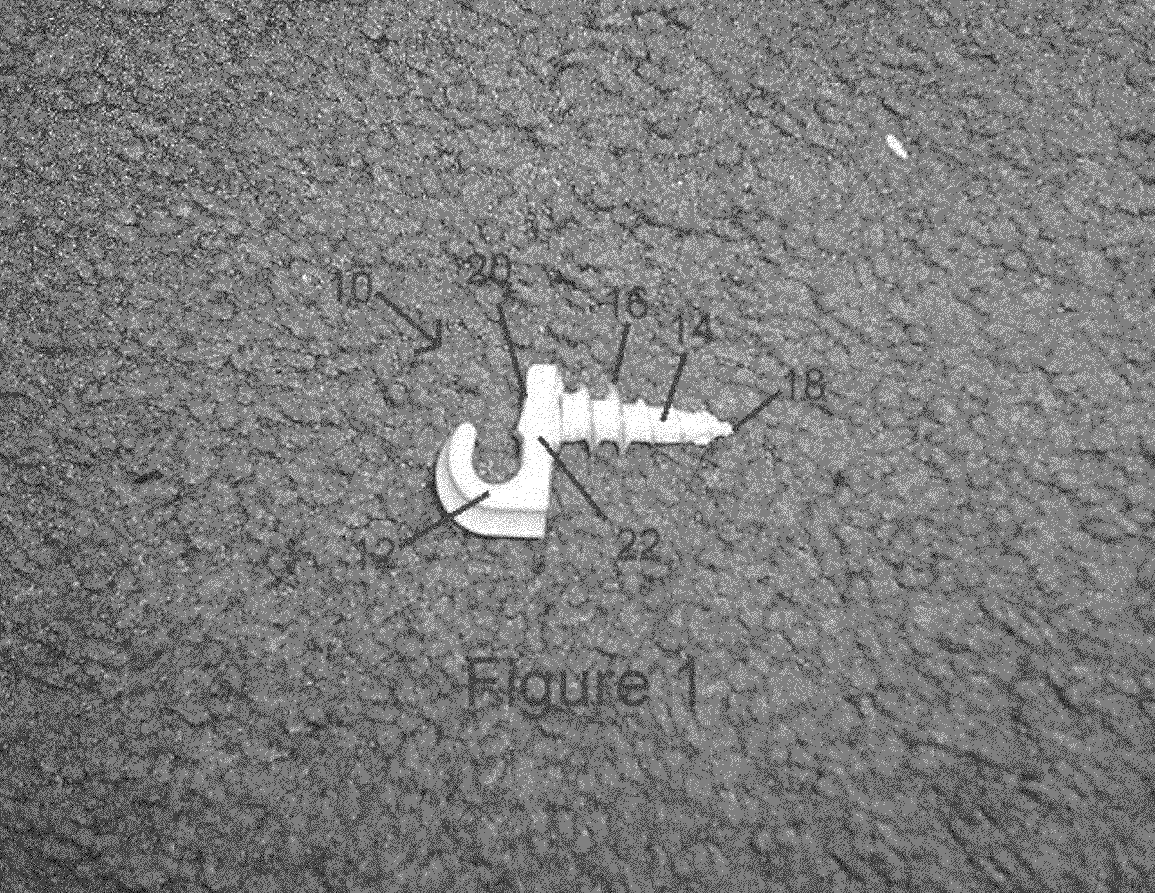

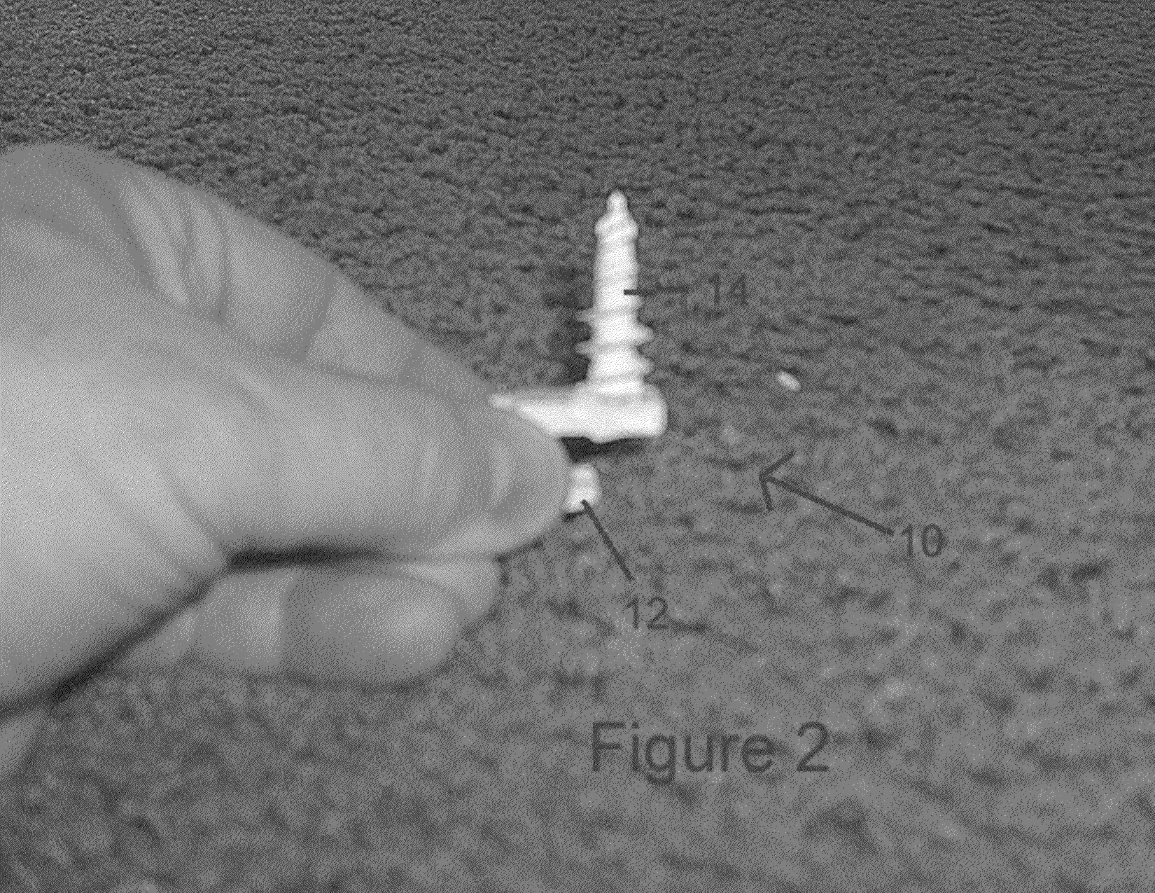

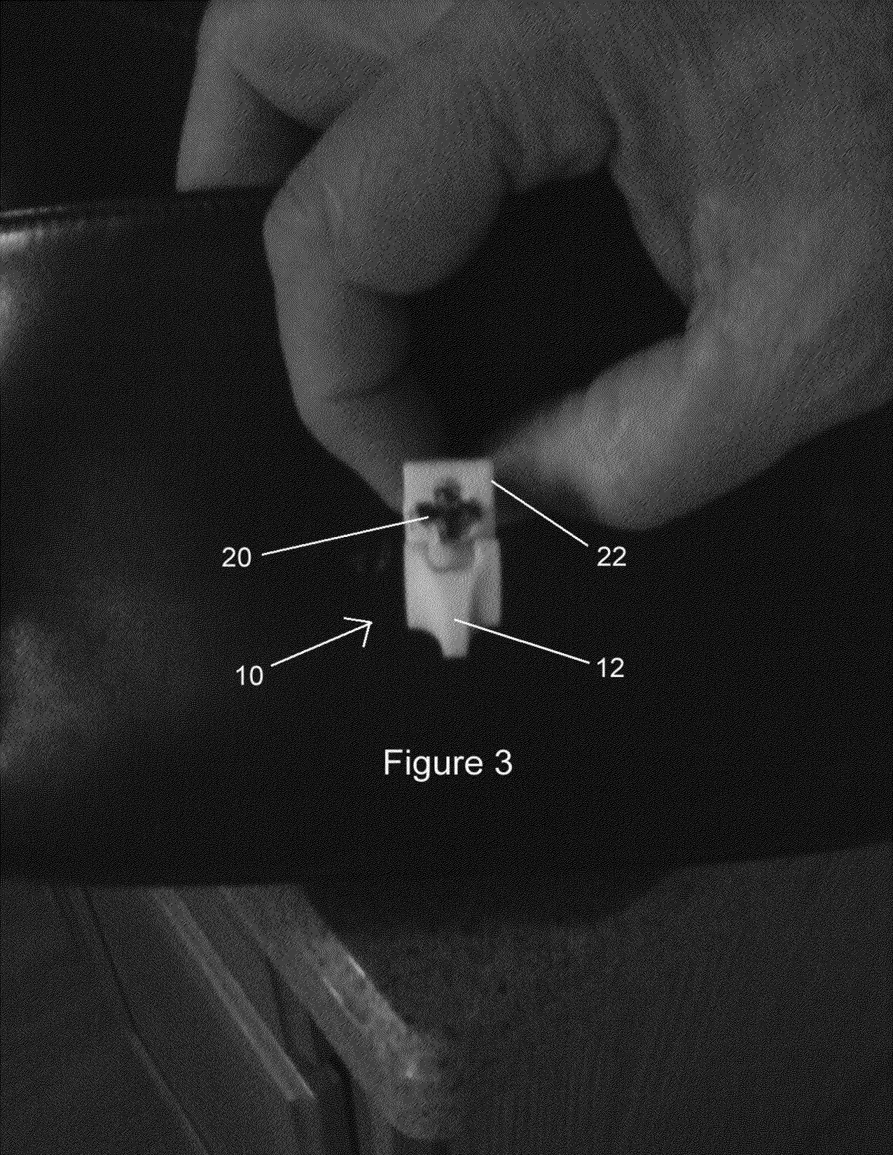

Referring now to FIGS. 1 through 3, a wall anchor 10 may include a clip 12 attached to an insertion end 14. The clip 12 may be a generally U-shaped hook that permits installation of wire shelving therewithin. In some embodiments, the clip 12 may be shaped to permit wire shelving to snap into and be retained by the clip 12. The clip 12 may be from about ¼ inch to about 1 inch in width, depending on application, however, other sized may be contemplated. Moreover, the clip 12 may be from about ¼ to about ¾ inch in diameter, depending on the diameter of the wire shelving.

The insertion end 14 may extend away from the clip 12 and form a single point 18 on its tip. This single point design results in clean cutting installations. The insertion end 14 may include threads 16 formed thereabout. The threads 16 may be a deep thread design that provides strong engagement in ⅜, ½, and 5/8 inch gypsum wallboard, for example. A deep thread design may be defined as where the threads extend away from the insertion end 14 by at least about one-half of the diameter of the insertion end 14.

A bit engagement area 20 may be formed on a front surface of a rear arm 22 of the wall anchor 10. The bit engagement area 20 may allow a user to quickly and easily install the wall anchor 10 with, for example, a Phillips screwdriver or square-drive bits.

The wall anchor 10 of the present invention may be made by various processes known in the art. For example, the wall anchor 10 may be made by a single molding process. The wall anchor 10 may be made from various materials, including plastic, metal, composite, or the like.

The wall anchor 10 of the present invention improves on the existing designs that typically have two components—a screw-type component, and a hook component. By creating a single-piece, simple device, the installation process for wire shelving can be greatly improved.

While the above description discusses using the wall anchor 10 for hanging wire shelving, it should be understood that the device may be suitably be used for other purposes. For example, the wall anchor 10 may be used as a picture hook.

It should be understood, of course, that the foregoing relates to exemplary embodiments of the invention and that modifications may be made without departing from the spirit and scope of the invention as set forth in the following claims.

What is claimed is:

1. A wall anchor comprising:
a hooked end;
an insertion end formed integrally with the hooked end;
threads disposed along the hooked end; and
a single point at a distal end of the insertion end, wherein the hooked end is adapted to secure onto wire shelving.

2. The wall anchor of claim 1, further comprising a bit engagement area formed on a front surface of a rear arm of the wall anchor.

3. The wall anchor of claim 1, wherein the threads are of a deep thread design.

4. A wall anchor comprising:
a hooked end;
an insertion end formed integrally with the hooked end;
threads disposed along the hooked end;
a single point at a distal end of the insertion end; and
a bit engagement area formed on a front surface of a rear arm of the wall anchor, wherein
the hooked end is adapted to secure onto wire shelving; and
the threads are of a deep thread design.

5. A method for securing wire shelving to a wall, the method comprising:
screwing an insertion end of a wall anchor into the wall via threads formed in the insertion end; and
disposing the wire shelving into a hooked end of the wall anchor, wherein the hooked end is formed integrally with the insertion end.

6. The method of claim 5, wherein the step of screwing an insertion end includes engaging a tool into a bit engagement portion of the wall anchor.

7. The method of claim 5, further comprising clipping the wire shelving into the hooked end to secure the wire shelving therewithin.
